(19) United States
(12) Patent Application Publication
(10) Pub. No.: US 2008/0297939 A1
(43) Pub. Date: Dec. 4, 2008

(54) Control circuit for implementing damage prediction diagnosis on read head element of magnetic head and protection operation on write data

(75) Inventor: Yoshihiro Amemiya, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/999,693

(22) Filed: Dec. 6, 2007

(30) Foreign Application Priority Data
Jun. 1, 2007 (JP) 2007-146409

(51) Int. Cl. G11B 21/02

(52) U.S. Cl. 360/75

(57) ABSTRACT

The present invention predicts and diagnoses damage to a read head element of a magnetic head used in a magnetic storage device. The present invention includes a control circuit for implementing a write data protection operation and for implementing a write and read operation using a different magnetic head when damage to the read head element is predicted, so as to allow detection of write data using a read element of a different magnetic head. The control circuit includes a monitor configured to detect a voltage of a read head element of a magnetic head, a comparator that determines whether the detected voltage exceeds a threshold voltage, the threshold voltage preferably being less than a maximum tolerable voltage of the read head element, and a counter configured to count signals passing through the comparator.

### BACKGROUND OF THE INVENTION

1. Field of the Invention

The present invention is a technology for predicting and diagnosing damage to a read head element of a magnetic head used in a magnetic storage device. The present invention further relates to a control circuit for implementing a write data protection operation and for implementing a write and read operation using a different magnetic head when damage to the read head element is predicted, so as to allow detection of write data using a read element of a different magnetic head.

2. Description of the Related Art

At present, together with demand for higher recording densities, faster transfer rates, and smaller sizes, there is demand for high reliability with regard to interference in magnetic storage devices. In magnetic storage devices, the part most vulnerable to interference is the read head element which has magneto-resistive effects of the magnetic head such as GMR (Giant Magneto Resistance). The tolerated voltage due to interference by the GMR read head element is very low at around 300 mV. In recent years, TuMR (Tunneling Magneto Resistance), which far surpasses the magneto-resistive effect ratio of GMR, has been used in mass-produced magnetic heads. However, read head elements using TuMR have a tolerated voltage due to interference of 200 mV which is even less that that of GMR read head elements. Generally, damage to the read head element is caused by overvoltage due to ESD (Electro-Static Discharge), EOS (Electro Over Stress) or the like. When overvoltage due to ESD or EOS occurs, the metal layers that make up the read head element melt or the magnetized arrangement known as the pinning layer disappears, thereby damaging the read head element and preventing the read head element from functioning properly.

It is well known that initially ESD is caused by contact between the magnetic head and the recording medium. Hence, to deal with this problem of contact between the recording medium and the read head element of the magnetic head, an acceleration sensor is provided in the magnetic storage device, and contact is avoided by sheltering the magnetic head from the recording medium when necessary. Although effective when the period of acceleration is comparatively long, such as when the device is dropped, this method is not effective against short period attacks. It is also well-known that EOS mainly occurs due to the effects of crosstalk from the write head element of the magnetic head. The following describes reasons for the occurrence of crosstalk.

FIG. 1 shows the internal parts of a normal magnetic storage device. The magnetic storage device 1 includes recording medium 24, a magnetic head 2 constructed from a read head element and a write head element mounted in a head slider, a head arm 25 that includes a suspension and a gimbal for holding the head slider, a VCM (Voice Coil Motor) 26 for driving the head arm 25, a head-amp IC 20 for controlling the read/write signals, and read/write channel LSI 17 having a PRML (Partial Response Maximum Likelihood) type signal processing circuit, a Viterbi decoder and the like. The magnetic head 2 and the head-amp IC 20 are connected using an FPC (Flexible Print Cable), which is not shown in the drawings. Though not shown, a plurality of the recording medium 24 and the magnetic head 2 are provided in the thickness direction of the magnetic storage device.

FIG. 2 shows a conventional transmission path construction of the head-amp IC 20 and the magnetic head 2. Wiring 22 of the read head element 4 and wiring 23 of the write head element 3 in the magnetic head 2 are formed on a FPC substrate 21, and each is connected to the head-amp IC 20. Here, the constraints due to miniaturization requirements of the magnetic storage device mean that the surface area of the FPC substrate 21 is necessarily small. Hence, it is necessary to narrow the wiring gap between the wiring 22 of the read head element 4 and the wiring 23 of the write head element 3. With the narrow wiring gap is as main causal factor, write current flowing in the wiring 23 of the write head element 3 causes wiring gap coupling, and crosstalk is generated in the wiring 22 of the read head element.

Distancing the wiring of the read head element and the write head element is an effective way of inhibiting the generation of cross-talk. However, as described above, widening the FPC substrate 21 to separate the wiring is impractical due to constraint of the device miniaturization requirements. In addition, in recent years, DFH (Dynamic Fly Height) technology (also known as TFC (Thermal Fly-height Control)) has been introduced. With DFH technology, a heater is formed in the magnetic head, current is passed through the heater and the resulting heat causes the magnetic head to expand. Since the wiring for the heater is provided on the same FPC substrate as the read and write head element wiring, the effects of cross talk have become a more serious problem than in the conventional technology. A further problem is that, as transfer rates become faster, the probability of resonant frequencies existing increases, causing the probability of crosstalk occurring to increase. In summary, the greater the increase in transfer rate and miniaturization of the magnetic storage device, the more impairment to the read head element caused by crosstalk becomes a concern.

As described above, the ESD caused by contact of the magnetic head and the recording medium, and the EOS caused by the effects of crosstalk cannot be completely eliminated. When the ESD and EOS cause overvoltage due to interference at the read head element and the read head deteriorates to a damaged condition, it becomes difficult to read recorded data written on the recording medium by the magnetic head. Note that deterioration of the read head element is not caused by a single occurrence of overvoltage due to ESD or EOS, but is generally the result of a load building over a plurality of overvoltage occurrences. This means that as time passes the magnetic storage device becomes less reliable. As a result of these conditions, it is currently the case that magnetic storage devices are insufficiently reliable.

It is a general object of the present invention to solve these problems. It is a more specific object of the present invention to aim to provide a highly reliable magnetic storage device. Specifically, potential damage to the read head element is predicted by detecting overvoltage on the read head element due to interference. Then, when damage is predicted, the recorded data on the recording medium used with the magnetic head, is transferred to a different recording medium, thereby securely protecting the recorded data and allowing read/write operations without using the magnetic head for which damage is predicted. These and other such techniques are used to increase the reliability of the magnetic storage device.

### SUMMARY

In accordance with an aspect of an embodiment, a control circuit that includes a monitor configured to detect a voltage of a read head element of a magnetic head, a comparator configured to determine whether the detected voltage exceeds a threshold voltage, the threshold voltage being less than maximum tolerable voltage of the read head element, and a counter configured to count signals passing through the comparator.

### BRIEF DESCRIPTION OF THE DRAWINGS

FIG. 1 shows the internal parts of a normal magnetic storage device.

FIG. 2 shows a normal transmission path construction between a head-amp IC and a magnetic head.

FIG. 3 shows a control circuit of an embodiment of the present invention.

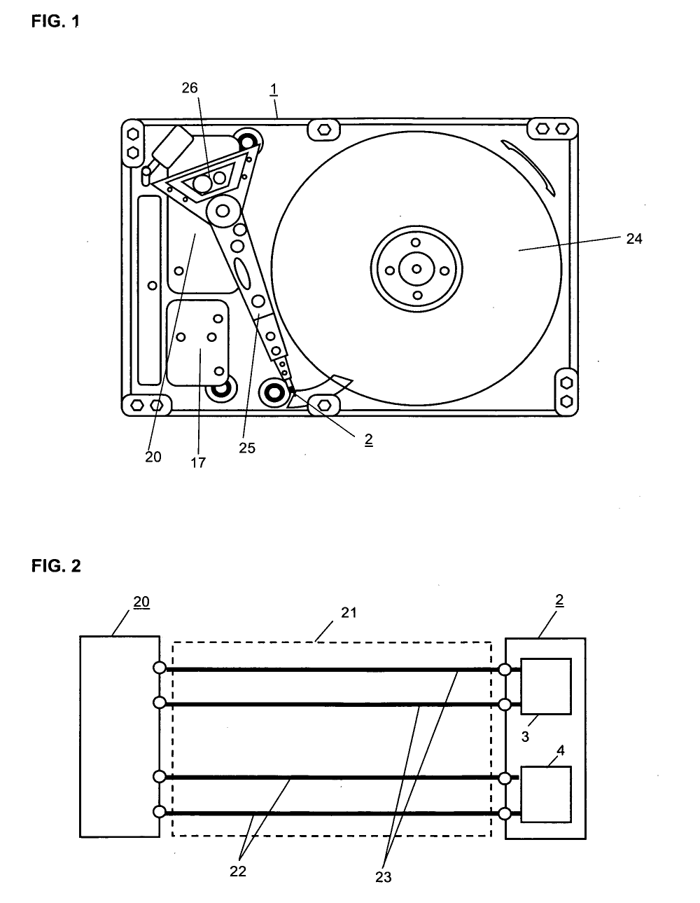

### DETAILED DESCRIPTION OF THE EMBODIMENTS

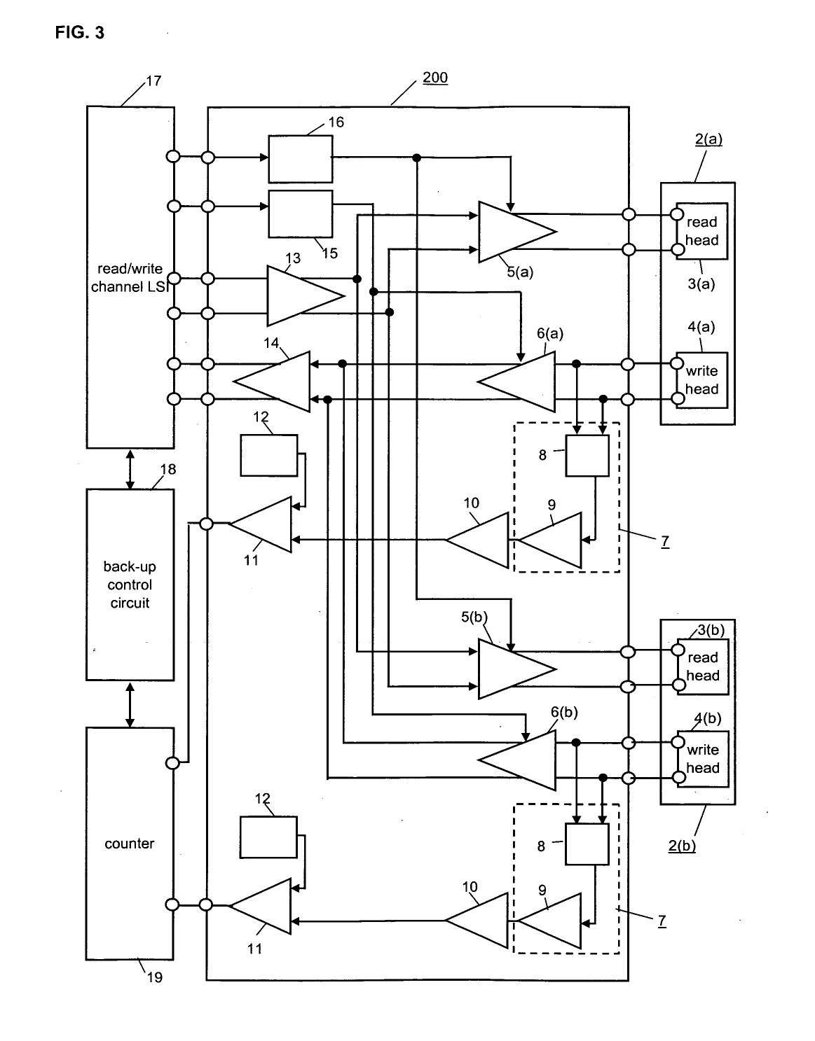

FIG. 3 shows a control circuit of the embodiments of the present invention. Note that, here, a control circuit using two magnetic heads 2(a) and 2(b) is described. The head-amp IC 200 includes write drivers 5(a) and 5(b) and a write driver buffer 13. The write drivers 5(a) and 5(b) are respectively connected to terminals of the write head elements 3(a) and 3(b) of the magnetic heads 2(a) and 2(b). The head-amp IC 200 also includes read amps 6(a) and 6(b) and a read data buffer 14. The read amps 6(a) and 6(b) are respectively connected to the terminals of the read head elements 4(a) and 4(b) of the magnetic heads 2(a) and 2(b). Also, a read amp switching control circuit 15 and a write driver switching control circuit 16 receive magnetic head read head element information and write head element information to be used in read/write operations via a read/write channel LSI 17, and function to cause the indicated read amp 6(a) or 6(b), or indicated write driver 5(a) or 5(b), to operate.

Next, a monitor 7 for detecting the voltage is provided between the read head elements 4(a) and 4(b) and the read amps 6(a) and 6(b). The monitor 7 is constructed from a circuit 8 which converts a differential signal to a single-end signal and a full-wave rectifier circuit 9 formed from a combination of diodes. The reason for this construction is that, although the write head elements 3(a) and 3(b) normally use differential signals on account of noise characteristics, the conversion of the differential signal to a single-end signal makes it possible to detect an absolute value of the voltage on the read head element. Instead of the full-wave rectifier circuit 9 formed from a combination of diodes, a peak hold circuit could be used to detect an absolute value of the voltage on the read head element. A gain amp 10 may also be provided to increase detection sensitivity. Next, a comparator 11 is provided to judge whether the detected voltage exceeds a threshold value voltage the read head element can tolerate without failure. The threshold value is preferably less than the maximum. A threshold value input unit 12 is connected to the comparator 11. Here, the threshold value of the tolerated voltage differs according to the performance of the magnetic head 2. Here, it may be assumed that a mass produced TuMR element or the like is used. In this case, since the tolerated voltage is of the order of 200 mV, the threshold voltage may be set to 180 mV. Another possibility is to find the tolerance voltages by deliberately applying voltages to a plurality of test sample heads, and use the average tolerated voltage as the threshold value.

Further, a counter 19 is provided to count the number of occurrences of ESD and EOS overvoltage capable of causing deterioration in the read head element. The counter 19 must store the number of occurrences of ESD and EOS overvoltage capable of causing deterioration in the read head element 4(a) and 4(b). Even when the storage device is not running, non-volatile flash memory is preferably used for this purpose. Note that the counter 19 can be provided in the head-amp IC 200. With this construction, it possible to count the number of occurrences of ESD and EOS overvoltage capable of causing deterioration in the read head elements 4(a) and 4(b). Note that the threshold value for the counter 19 may be experimentally investigated in a similar way to the threshold value for the tolerated voltage of the read head element, by deliberately and repeatedly applying voltages near the tolerated voltage and counting the number of applications of the voltage tolerable by the head.

A back-up control circuit 18 is provided to execute a back-up operation on the recorded data when the counter 19 reaches the threshold value. The back-up control circuit 18 is connected to the counter 19, and outputs a back-up instruction to the read/write channel LSI 17 when the counter 19 reaches the threshold value. The following describes an example of operations when the threshold value for the read head element 3(a) of the magnetic head 2(a) is exceeded and damage is predicted. Having received the back-up instruction, the read/write channel LSI 17 causes the read amp 6(a) to operate using the read amp switching control circuit 15. The recorded data is then transmitted to the read/write channel LSI 17 via the read data buffer 14. Next, the read/write channel LSI 17 causes the write driver 5(b) to operate using the write driver switching control circuit 16, and a executes a back-up operation. In the back-up operation, the recorded data read by the read head element 3(a) is recorded on a recording medium by the write head element 3(b) of the other magnetic head 2(b). After the back-up operation, if an instruction for a reading or writing operation using the magnetic head 2(a), for which the count has reached the threshold value, is received from the host, the read/write channel LSI 17 uses the magnetic head 2(b) for which the count has not reached the threshold value. By these operations, it is possible to implement read and write operation without using the magnetic head 2(b) for which the deterioration in characteristics has been predicted.

With this type of construction, the number of occurrences of overvoltage caused by ESD (Electro-Static Discharge), EOS (Electro Over Stress) or the like capable of causing deterioration in the read head element can be counted. Then, when the count reaches a threshold value set on the counter, the recording data on the recording medium assigned to a given magnetic head is read by the given magnetic head. Then, the recording data on the recording medium assigned by the given magnetic head is switched over to the magnetic head for which the count has not reached the threshold value. These operations allow the recorded data to be backed up.

Moreover, after backing up the recorded data, when an instruction is received from the host for a read/write operation using the magnetic head which has exceeded the threshold value, the operation is executed by a different one of the plurality of magnetic heads provided in the magnetic storage device, thereby enabling execution of the read/write operation without using the magnetic head for which damage due to overvoltage has been predicted.

Note that when the counter 19 is connected to a SMART (Self Monitoring Analysis and Report Technology) control circuit, which is not shown in the drawings, it is possible to prompt the user to change to a new magnetic storage device by giving the user information about the implementation of the back-up and the number of occurrences of overvoltage due to ESD or EOS.

Thus, through use of the control circuit of the embodiment, the number of occurrences of overvoltage due to interference capable of causing deterioration in characteristics of the read head element is counted. Then, based on the number of occurrences, use of the magnetic head is stopped and back-up of the recorded data is implemented. By these operations, the recorded data can be securely protected. As a result, a magnetic storage device having high reliability can be provided.

What is claimed is:

1. A control circuit comprising:
a monitor configured to detect a voltage of a read head element of a magnetic head;
a comparator configured to determine whether the detected voltage exceeds a threshold voltage; and
a counter configured to count signals passing through the comparator.

2. The control circuit of claim 1, wherein the threshold voltage is less than a maximum voltage tolerably by the read head element.

3. The control circuit according to claim 1, further comprising:
a back-up control circuit configured to transfer, when the counter count has reached a preset threshold value, recorded data from a recording medium using the magnetic head corresponding to the count that has reached the threshold value to a different recording medium.

4. The control circuit according to claim 3, wherein
after transferring, when the counter count has reached a preset threshold value, recorded data from a recording medium that used the magnetic head corresponding to the count that has reached the threshold value to a different recording medium, the back-up control circuit executes a read/write operation using a different magnetic head.

5. The control circuit according to claim 1, wherein
the counter outputs an alarm to a user when a count reaches a preset threshold value.

6. The control circuit of claim 1, wherein
the monitor includes a circuit for converting a differential signal to a single-end signal.

7. A magnetic storage device comprising:
a control circuit including a monitor for detecting a voltage on a read head element of a magnetic head;
a comparator configured to determine whether the detected voltage exceeds a threshold voltage;
a counter configured to count signals passing through the comparator;
at least one magnetic head configured to execute a read/write operation; and
at least one recording medium.

8. The magnetic storage device of claim 7, wherein the threshold voltage is less than a maximum voltage tolerably by the read head element.

9. The magnetic storage device according to claim 7, further comprising:
a back-up control circuit configured to transfer, when the counter count has reached a preset threshold value, recorded data from a recording medium using the magnetic head corresponding to the count that has reached the threshold value, to a different recording medium.
